(19) United States
(12) Patent Application Publication
(10) Pub. No.: US 2002/0191484 A1
(43) Pub. Date: Dec. 19, 2002

(54) Device at an apparatus for preparing and extrusion of bone cement

(76) Inventor: Soren Jonsson, Linkoping (SE)

Correspondence Address: MERCHANT & GOULD PC, P.O. BOX 2903, MINNEAPOLIS, MN, 55402-0903, US

(21) Appl. No.: 09/881,162

(22) Filed: Jun. 14, 2001

(30) Foreign Application Priority Data
Jun. 14, 2001 (SE) SE01/01346

(51) Int. Cl. B01F 13/06

(52) U.S. Cl. 366/139

(57) ABSTRACT

The present invention relates to a device at an apparatus for preparing and extrusion of bone cement. The apparatus comprises a mixing chamber (1) equipped with a vacuum connection (2) and has a, in the opposite part of the mixing chamber (1), moveable wall section (6) arranged to be pushed into the mixing chamber (1) after preparation under vacuum and then to extrude bone cement through an extrusion opening arranged in the opposite part of the mixing chamber (1). The invention is characterized in that the moveable wall section (6) is sealingly connected with a corresponding end of the mixing chamber (1) in such a way that the connection is breakable when applying a for breakage sufficient force to the moveable wall section (6).

### BACKGROUND OF THE INVENTION

The present invention relates to a device according to the preamble of claim 1.

A similar apparatus for preparing and extrusion of bone cement is previously known from e.g. EP 90903630.3, publication no. EP 0470959 B1.

When preparing bone cement two components are mixed together under vacuum whereby, considering the future strength of the bone cement, it is important that no air leak into the mixing chamber during preparation. Preventing leakage is particularly important between the side wall of the mixing chamber and its moveable wall section, which later on will function as a piston, since air leaking in may be mixed in to the bone cement along the whole length of the mixing chamber. To prevent air from leaking in, as far as possible, one or several O-rings are commonly arranged between the movable wall section and the sidewall of the mixing chamber. Leakage is thereby indeed prevented, however at the same time as the disadvantage appears that, when the ready-mixed bone cement is extruded, appearing frictional forces will cause the power necessary to move the moveable wall section into the mixing chamber to be unsatisfactorily high.

### SUMMARY OF THE INVENTION

The object of the present invention is to provide an improved sealing between the moveable wall section and the side wall of the mixing chamber without the abovementioned disadvantages appearing. This is achieved, according to the invention, by means of the indicated features in the characterizing part of claim 1.

### BRIEF DESCRIPTION OF THE DRAWING

In the following the invention will be explained in more detail by means of an example of an embodiment of the present invention and with reference to the accompanying drawing.

FIG. 1a illustrates a mixing chamber according to the present invention and in FIG. 1b an enlarged sectional view is illustrated of a moveable wall section of the mixing chamber at one of its ends.

Designation 1 in the drawing indicates a mixing chamber intended for preparation and extrusion of bone cement. The mixing chamber 1 is equipped with a vacuum connection 2 and an agitator device comprising of an agitator rod 3 with an axial extrusion channel for bone cement and an agitator (not shown) arranged around the end of agitator rod 3 within the mixing chamber 1.

Agitator rod 3 is axially moveable in mixing chamber 1 through opening 4, which is sealed against agitator rod 3. The orifice of the channel of agitator rod 3 in mixing chamber 1, forms an extrusion opening for bone cement at the agitator. Before mixing a sealing rod is inserted into the channel of agitator rod 3 to keep extrusion opening sealed during mixing.

At an opposite end 5 relative to opening 4, mixing chamber 1 has a moveable wall section 6 which may be moved in direction of the extrusion opening. The moveable wall section 6 is formed with a flange 7 connecting the end 5 of the mixing chamber 1 and around which flange 7 an indication of fraction 8 extends. Furthermore an O-ring 9 is arranged around the moveable wall section 6.

### DESCRIPTION OF THE INVENTION

The constituent components of bone cement are mixed under vacuum in mixing chamber 1. The mixing is performed according to a method, well known to anyone skilled in the art, at which the agitator arranged around agitator rod 3 is brought to mix the bone cement components. When mixing is finished the agitator rod 3 is moved out of the mixing chamber 1 as far as possible, which implies that the agitator and the extrusion opening are placed in connection to the wall of mixing chamber 1 formed with opening 4. The extrusion process may then start, this is based on the moveable wall section 6 being moved into the mixing chamber 1 under influence of the vacuum therein and an applied force. The bone cement in the mixing chamber 1 is then moved by the moveable wall section 6 towards the extrusionopening and into the channel of agitator rod 3.

According to the present invention a sealing connection is formed between the moveable wall section 6 and end 5 of mixing chamber 1, in order to prevent air from leaking in through the seam between them during mixing. In the device illustrated in

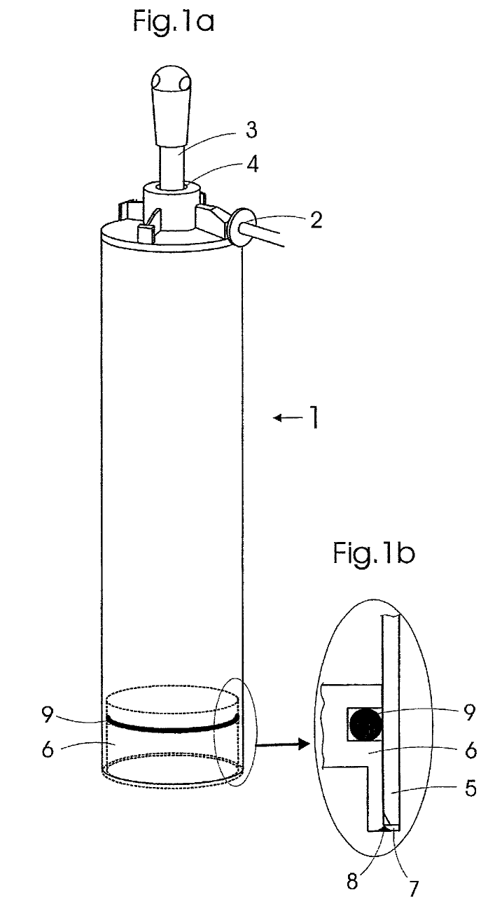

FIG. 1a and 1b according to the invention, the sealing connection is provided by connecting flange 7 of the moveable wall section 6 with end 5 of mixing chamber 1 and obtained by a welding seam between flange 7 and end 5, provided for example by means of ultrasound.

The sealing connection also implies that the moveable wall section 6 is fixed at end 5, which means that the moveable wall section 6 is prevented from moving into mixing chamber 1 under influence of the vacuum therein. This fixation is desired during mixing, but the sealing connection is formed to be breakable so that the moveable wall section 6 may be moved during the extrusion process. The indication of fraction 8 extends around flange 7 in the device according to the invention, such that the sealing connection and thus the fixation is broken when a for breakage sufficient force is applied to the moveable wall section 6. Furthermore the O-ring 9 is arranged around the moveable wall section 6 to prevent leakage of air into mixing chamber 1 when the sealing connection is broken and the moveable wall section 6 moved.

What is claimed is:

1. Device at an apparatus intended for preparing and extrusion of bone cement comprising a mixing chamber (1) equipped with a vacuum connection (2), having a, in the direction of the opposite part of the mixing chamber (1), moveable wall section (6), which is arranged to be pushed into the mixing chamber (1) like a piston under influence of vacuum therein after preparation under vacuum and then to extrude the bone cement through an extrusion opening arranged in the opposite part of the mixing chamber (1), characterized in, that the moveable wall section (6) is sealingly connected with corresponding end (5) of the mixing chamber (1) in such a way that the connection is breakable when applying a for breakage sufficient force to the moveable wall section (6).

2. Device according to claim 1, characterized in, that the moveable wall section (6) is formed with a flange (7), which flange (7) is sealingly connected with the end (5) of the mixing chamber (1) by a welding seam provided by for example ultrasound and has an indication of fraction (8) extending around the flange (7).
